(19) United States
(12) Patent Application Publication
(10) Pub. No.: US 2015/0193496 A1
(43) Pub. Date: Jul. 9, 2015

(54) INDOOR POSITIONING SERVICE SCANNING WITH TRAP ENHANCEMENT

(71) Applicant: International Business Machines Corporation, Armonk, NY (US)

(72) Inventors: Bruce A. Crawford, Clifton Forge, VA (US); Rebecca E. Lutz, Orlando, FL (US); Todd D. Robinson, Frederick, CO (US)

(73) Assignee: International Business Machines Corporation, Armonk, NY (US)

(21) Appl. No.: 14/150,383

(22) Filed: Jan. 8, 2014

(51) Int. Cl. G06F 17/30

(52) U.S. Cl. CPC G06F 17/30386

(57) ABSTRACT

A method of an event management system trapping changes using a server in an indoor positioning system with trap management to a plurality of devices each having a transponder within a location having a plurality of anchor nodes at fixed locations.

### BACKGROUND

The present invention relates to enterprise data management systems, and more specifically to enterprise data management systems with trap enhancement having data center indoor positioning service scanning.

In computing and operating systems, a trap, also known as an exception or a fault, is typically a type of synchronous interrupt typically caused by an exceptional condition. In network management protocol, a trap management system is used to report an alert or other synchronous event about conditions arising in a managed subsystem.

In enterprise data management systems, obtaining demographic and location based device configuration data is difficult. Demographic data population in a trap management system is inputted through manual data entry upon initial system deployment, configuration and moves. Manual keying of data can cause incorrectly entered or missing data, require a need for a user to remember to update data manually as assets are moved, require the user to remember the ongoing costs associated with manual intervention, and latency in the data integration with a trap management and billing system. Furthermore, as assets added to, moved within, or removed from the system, the movement of the assets, including secured assets, are not tracked, requiring manual entry and updating and making it challenging to align unapproved change incidents with surveillance.

### SUMMARY

According to one embodiment of the present invention a method of an event management system trapping changes using a server in an indoor positioning system with trap management to a plurality of devices within a location having a plurality of anchor nodes at fixed locations; each device having a transponder. The method comprising the steps of: the server receiving instructions to scan a location to locate the plurality devices within a range; the server initiating the plurality of anchor nodes to perform a current scan of the location to actively locate the plurality of devices within the location; the server receiving current scan data regarding positions of the plurality of devices from the plurality of anchor nodes, wherein the position of each of the devices is measured from at least three different anchor nodes; the server storing the current scan data in a repository; the server comparing the current scan data to data stored in the repository from a previous scan to trap changes to the devices within the location; and if the current scan data is different from the data stored in the repository from a previous scan, indicating that a change is trapped, the server sending data regarding the trapped change to a configuration management database of an event management system.

### BRIEF DESCRIPTION OF THE SEVERAL VIEWS OF THE DRAWINGS

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a schematic of the indoor positioning system at a location in communication with a cloud computing environment of an embodiment of the present invention.

FIG. 5 shows a flowchart of a method of establishing a baseline for the positioning of devices within a location.

FIG. 6 shows a flowchart of a method of detecting changes regarding the positioning of devices within a location through trap enhancement.

### DETAILED DESCRIPTION

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

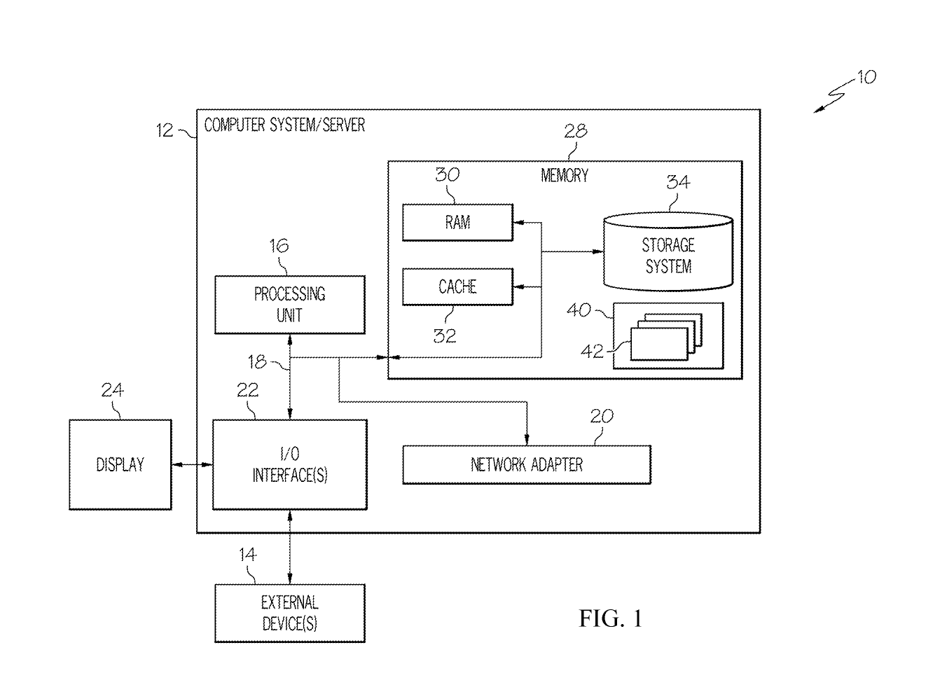

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

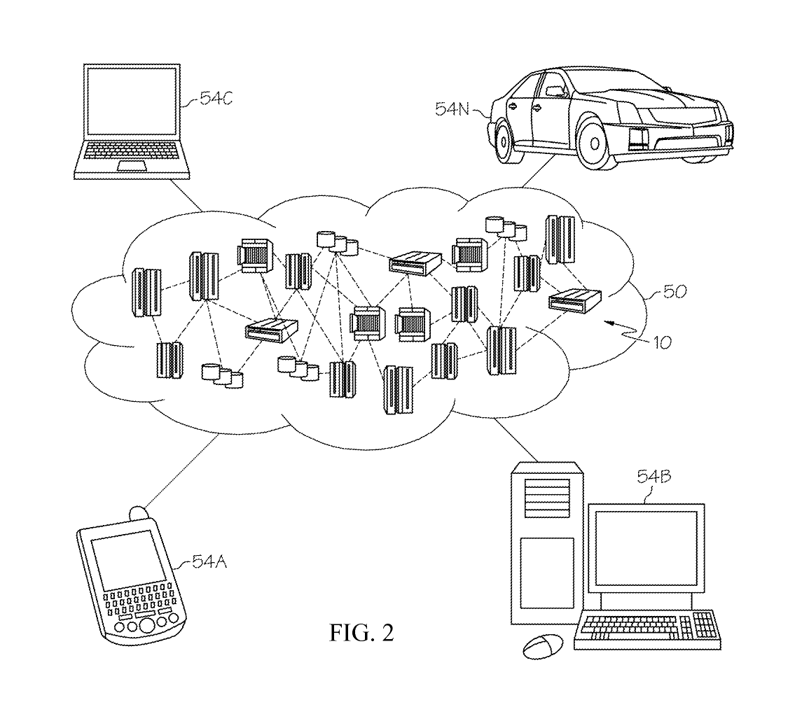

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

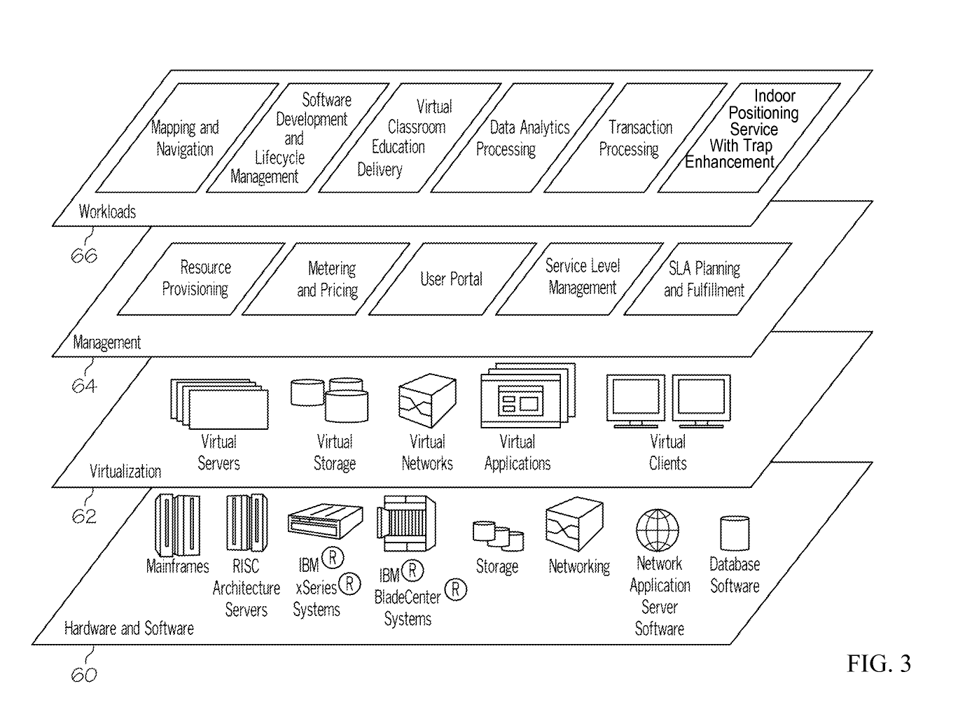

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and indoor positioning service with trap enhancement.

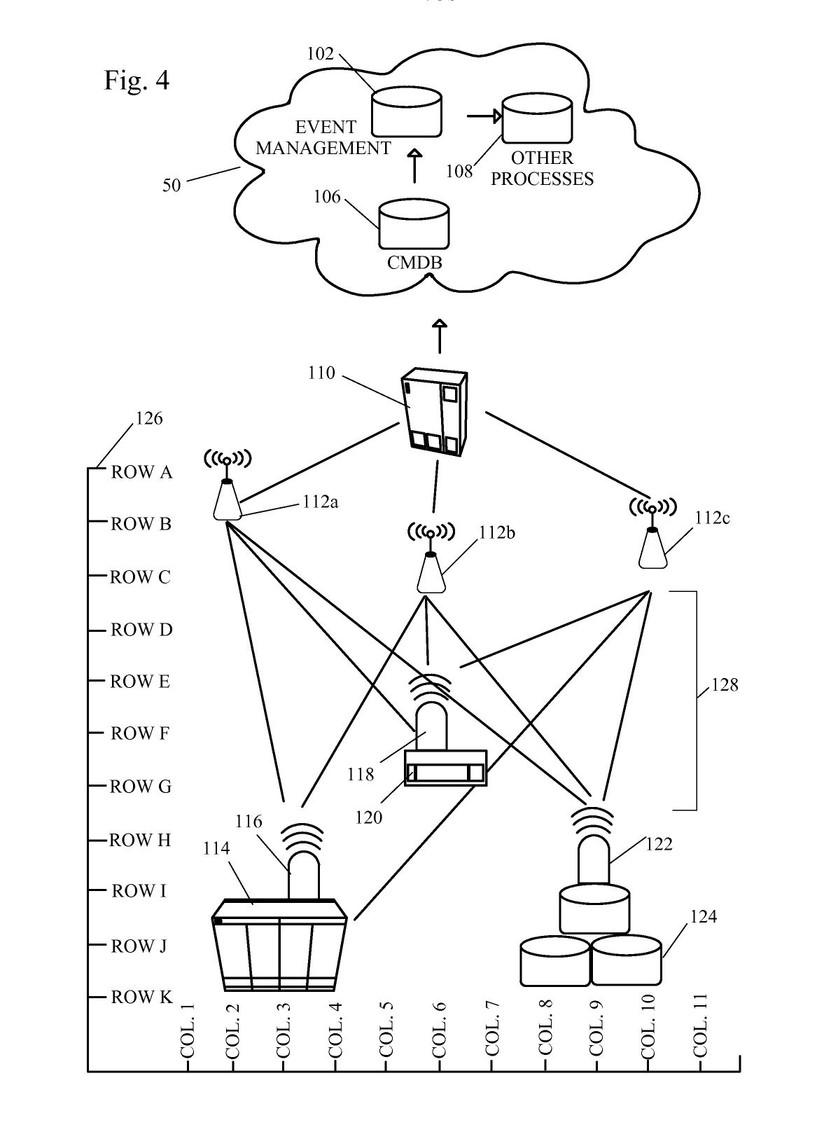

In an illustrative embodiment of the present invention, as shown in FIG. 4, it is recognized that the present invention quickly and accurately allows for detection of changes associated with devices at a particular location, allowing for billing associated with the devices at the location to be more accurate and timely.

In an illustrative embodiment of the present invention, it is also recognized that by automatically scanning a location for positioning data of devices, and associating the positioning data with a timestamp, any monitoring for specific changes regarding the devices at the location can be further enhanced and aligned with surveillance detection video and access logs of the same location.

In an illustrative embodiment of the present invention, it is also recognized that by automatically and regularly scanning devices within locations and using traps to detect specific changes that occur regarding the devices, the IT systems management system is accurate and comprehensive, and may be used to configure item updates and maintenance at specific locations and to generate notification or tickets for a user to verify.

An indoor positioning system (IPS) is a network of devices used to wirelessly locate objects or people inside a building. FIG. 4 shows a schematic of an indoor positioning system (IPS) at a location in communication with a cloud computing environment of an embodiment of the present invention. Devices, for example server racks, routers, storage systems, servers, printers, personal computers, and other devices are setup on a raised floor or structure with specific positions within a location.

In FIG. 4, three devices are shown, but numerous devices may be present at a location. The three devices present in FIG. 4 for example purposes are a server rack 114, a router 120 and a storage system 124, each with their own wireless transponder 116, 118, and 122 respectively. Anchor node 112a is located at a fixed position of Row A and Column 2 Anchor node 112b is located at a fixed position of Row C, Column 6 and anchor node 112c is located at a position of Row B, Column 10. The anchor nodes 112a, 112b, 112c convey information regarding detected devices to an IPS data server 110. The wireless transponders 116, 118 and 122 allow the devices to provide feedback to the anchor nodes 112a-112c.

The devices 114, 120, 124 are present within the location at specific position on a raised floor at the location. The raised floor or grid system 126 has rows and columns to identify the position of the devices 114, 120, 124. For example, the server rack 114 is located in Row K and Row J and in Columns 2, 3, and 4. The router 120 is present in Rows F and G and in Columns 6 and 7. The storage system 124 is located in Rows I, J and K and in Columns 8, 9, and 10.

The wireless transponders 116, 118 and 122 of each of the devices 114, 120, 124 can convey data regarding the device itself to anchor nodes 112a, 112b, 112c, which, as noted above, are at fixed locations on the raised floor 126 at the location.

The anchor nodes 112a, 112b, 112c preferably actively locate the transponders of the devices through one of the known techniques used to sense a device in a certain known fixed location, for example by sending a signal 128 via radio to a device and measuring time delays in received signals from dispersed locations. In the example, the position of each device can be located through three independent measures to each target, one from each of the anchor nodes 112a, 112b, 112c.

It should be noted that while radio signals are being used in the present invention, the anchor nodes 112a, 112b, 112c and location communication protocols are agnostic to the types of devices managed, and other forms of measurement could be used, such as location through acoustic or optical signals.

The data regarding the position of the devices 114, 120, 124 in the location derived from the anchor nodes 112a, 112b, 112c is communicated to and stored within an IPS data server 110 at the location. The data regarding the position of the devices and any other data associated with the devices may be stored in a log file. The IPS data server 110 associates the position data with a unique identifier for the device, such as serial number; the indoor location coordinates of the device at the location; and a timestamp of the current scan. Additional information such as geographic location, facility name, and data center name may also be registered for the devices.

The IPS data server 110 has monitoring agents that use an enterprise trap management system to compare a current scan to a previous scan to recognize and trap different changes that may represent operational or security concerns. The changes that are captured through traps of the enterprise trap management system of the IPS data server 110 are “new device”, “device missing”, and “new coordinates”, and are provided to a configuration management database (CMDB) 106 of a computing system, preferably within a cloud computing environment 50. The traps of the enterprise trap management system may be altered within the cloud computing environment and updated on the IPS data server 110.

A change of “new device” is detected and trapped by the enterprise trap management system when a device is unknown, i.e. not detected in a previous scan and present in a current scan.

A change of “device missing” is detected and trapped by the enterprise trap management system when a device known from a previous scan was not found on the current scan.

A change of “new coordinates” is detected and trapped by the enterprise trap management system when a device has indoor coordinates in a current scan that do not match the indoor coordinates for the same device in a previous scans.

CMDB 106 on the cloud computing environment 50 of the present invention maintains a historical and current demographic data regarding the devices at specific locations. Through an event management system 102 within the cloud computing environment 50, the data of the CMDB 106 may be used for tracking, reporting, billing and other functions over time within the cloud computing environment 50.

The data in the CMDB 106 regarding the demographic data of devices at specific locations may be integrated through the event management system 102 with other systems and processes 108, for example a security operations center (SOC), a network operations center (NOC), an IT service management (ITSM) ticketing and asset system, configuration management repositories, notification systems such as e-mail and short message service (SMS), billing systems, and other reporting systems.

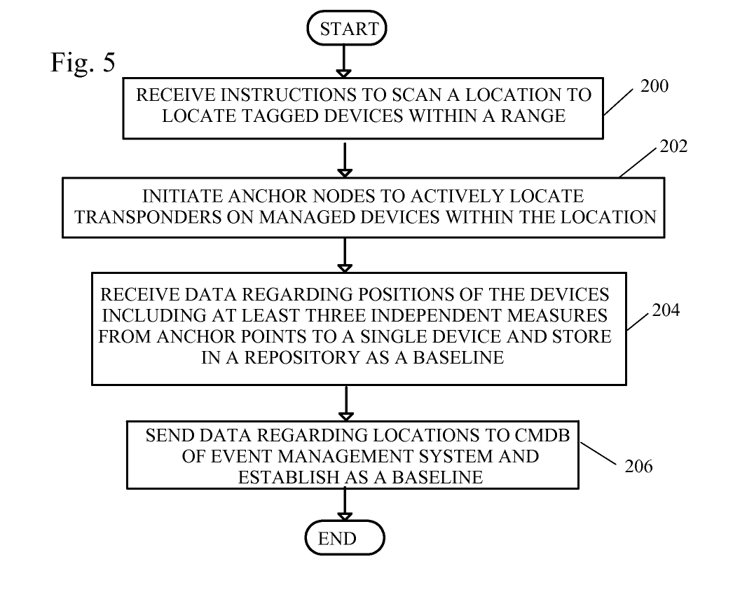

FIG. 5 shows a flowchart of a method of establishing a baseline for the positioning of devices within a location.

In a first step, an IPS data server 110 receives instructions to scan a location to locate devices within a range (step 200). The instructions may be from a user at the location or from the cloud computing environment 50.

The IPS data server 110 initiates anchor nodes 112a, 112b, 112c to actively locate transponders on devices within the location (step 202). The step of actively locating may be done by receiving radio signals or other types of signals from the wireless transponders of the devices within a specific location. The signals can be measured relative to the fixed, known location of the anchor nodes.

The IPS data server 110 receives data regarding positions of the devices at the location from anchor nodes 112a-112c and the IPS data server 110 stores the data in a repository at the location as a baseline (step 204). The data regarding the positions of the devices at the location preferably includes at least three independent measurements from the anchor nodes 112a-112c to a single device. The data may be stored in the repository of the IPS data server 110 as a log file.

The IPS data server 110 sends the data regarding the positions of the devices at the location and established as a baseline to the CMDB 106 within the cloud computing environment 50 (step 206).

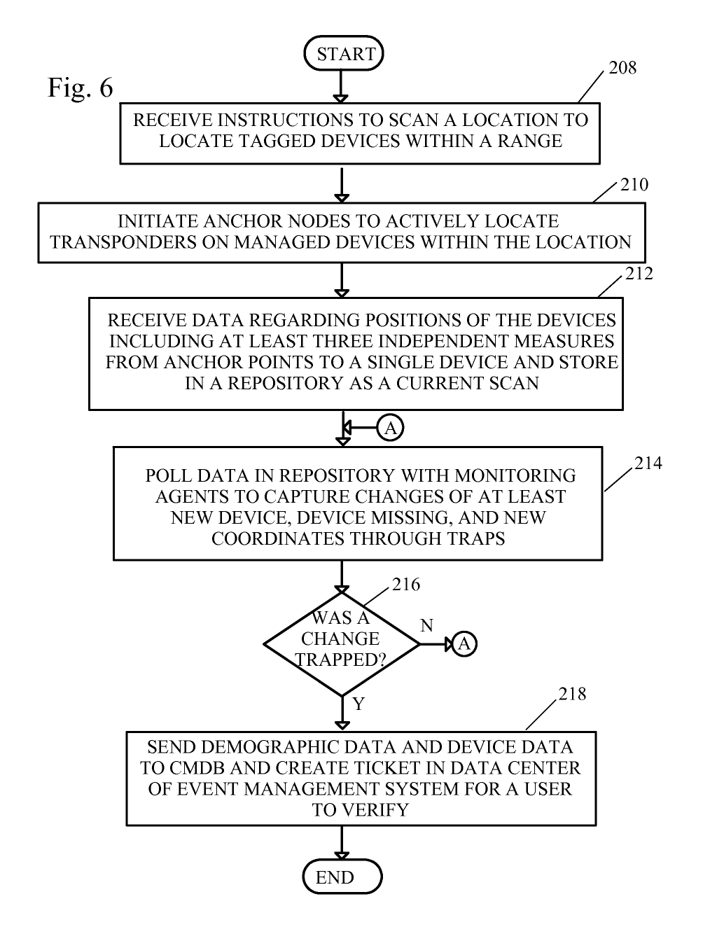

FIG. 6 shows a flowchart of a method of detecting changes regarding the positioning of devices within a location through trap enhancement.

In a first step, a IPS data server 110 receives instructions to scan a location to locate devices within a range (step 208). The instructions may be from a user at the location or from the cloud computing environment 50.

The IPS data server initiates anchor nodes 112a-112c to actively locate transponders on devices within the location (step 210). The active location may include receiving radio signals or other types of signals from the wireless transponders of the devices within a specific location. The strength of the signals can be measured relative to the fixed, known location of the anchor nodes.

The IPS data server 110 receives data regarding positions of the devices at the location from anchor points 112a-112c and the IPS data server 110 stores the data in a repository at the location as a current or latest scan, replacing a previous scan (step 212). It should be noted that in preferred embodiment, that the scans are not removed from the repository. The data regarding the positions of the devices at the location preferably includes at least three independent measurements from the anchor points to a single device. The data may be stored in the repository as a log file.

Monitoring agents of the IPS data servers 110 poll the data in the repository to capture changes of at least a “new device”, “device missing”, and “new coordinates” through traps of an enterprise trap management system (step 214).

If a change was not trapped (step 216), the method returns to step 214 of polling the date in the repository to capture changes.

If a change was trapped (step 216), the IPS data server 110 sends demographic data and device data to the CMDB 106 within the cloud computing environment 50 and creates a ticket in the event management system for a user to investigate (step 218) and the method ends.

Once the demographic data and device data has been sent to the CMDB 106 due to a change, a user can easily use surveillance video or data with the demographic data and device data which has a timestamp to aid in determining what may have happened to cause the trap to capture a change.

The demographic data and device data that has been sent to the CMDB 106 due to a change, can also be used to update billing and propagate the changes to the inventory for clients that pay per device.

Furthermore, the demographic data and the device data that has been sent to the CMDB 106 due to a change, may also be used to coordinate configuration item updates of the devices and schedule appropriate maintenance within the locations.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present

invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of an event management system trapping changes using a server in an indoor positioning system with trap management to a plurality of devices within a location having a plurality of anchor nodes at fixed locations; each device having a transponder, the method comprising the steps of:
the server receiving instructions to scan a location to locate the plurality devices within a range;
the server initiating the plurality of anchor nodes to perform a current scan of the location to actively locate the plurality of devices within the location;
the server receiving current scan data regarding positions of the plurality of devices from the plurality of anchor nodes, wherein the position of each of the devices is measured from at least three different anchor nodes;
the server storing the current scan data in a repository;
the server comparing the current scan data to data stored in the repository from a previous scan to trap changes to the devices within the location; and
if the current scan data is different from the data stored in the repository from a previous scan, indicating that a change is trapped, the server sending data regarding the trapped change to a configuration management database of an event management system.

2. The method of claim 1, wherein when the current scan data contains a device which is not in the data stored in the repository from a previous scan, the change is trapped as a new device.

3. The method of claim 1, wherein when the current scan data does not contain a device which is in the data stored in the repository from a previous scan, the change is trapped as a device missing.

4. The method of claim 1, wherein when coordinates for a device in the current scan data are different from coordinates for the same device in the data stored in the repository from a previous scan, the change is trapped as new coordinates.

5. The method of claim 1, further comprising the server establishing a baseline scan of the system by the steps of:
the server initiating the plurality of anchor nodes to perform a scan of the location to actively locate the plurality of devices within the location;
the server receiving scan data regarding positions of the plurality of devices from the plurality of anchor nodes, wherein the position of each of the devices is measured from at least three different anchor nodes;
the server storing the scan data in a repository as a baseline scan;
sending data from the baseline scan regarding the positions of each of the devices to the configuration management database of the event management system.

6. The method of claim 1, further comprising the step of the event management system sending data to a security operations center regarding a change sent by the server.

7. The method of claim 1, further comprising the step of the event management system sending data to an IT service management ticketing and asset system regarding a change sent by the server.

8. The method of claim 1, further comprising the step of the event management system sending data to a network operations center regarding a change sent by the server.

9. The method of claim 1, further comprising the step of the event management system sending data to a billing system regarding a change sent by the server.

10. The method of claim 1, wherein the current scan data is stored in a repository as a log file.
